(19) United States
(12) Patent Application Publication
(10) Pub. No.: US 2013/0240665 A1
(43) Pub. Date: Sep. 19, 2013

(54) METHOD FOR IMPROVING EFFICIENCY OF AIRPORT DEICING OPERATIONS

(71) Applicants: Isaiah W. Cox, Baltimore, MD (US); Rodney T. Cox, North Plains, OR (US)

(72) Inventors: Isaiah W. Cox, Baltimore, MD (US); Rodney T. Cox, North Plains, OR (US)

(73) Assignee: BOREALIS TECHNICAL LIMITED, London (GB)

(21) Appl. No.: 13/802,720

(22) Filed: Mar. 14, 2013

Related U.S. Application Data
(60) Provisional application No. 61/612,010, filed on Mar. 16, 2012.

(51) Int. Cl. B64C 25/40

(52) U.S. Cl. CPC B64C 25/405
USPC 244/50

(57) ABSTRACT

A method for improving the efficiency of airport deicing operations is provided. The present method equips aircraft using an airport with onboard non-engine drive means powered to drive one or more landing gear wheels to move the aircraft on the ground autonomously during taxi without reliance on the aircraft's engines. Decreasing or substantially eliminating the operation of aircraft engines during taxi substantially eliminates the likelihood that ice, snow, slush, and other runway contaminants moved by the jet blast produced by aircraft engine operation during taxi will be sprayed from the runway onto surfaces of taxiing aircraft, both prior to deicing and after deicing. Deicing operations can be conducted more quickly, and repeated deicing operations on a single aircraft can be avoided.

### PRIORITY CLAIM

This application claims priority from U.S. Provisional Patent Application No. 61/612,010, filed Mar. 16, 2012, the disclosure of which is fully incorporated herein.

### TECHNICAL FIELD

The present invention relates generally to methods for improving airport operations and specifically to a method for improving the efficiency of airport deicing operations when multiple aircraft are equipped with onboard drive means for independent ground travel.

### BACKGROUND OF THE INVENTION

The safety of air travel during inclement winter weather has increased as procedures relating to safe cold weather operations have been implemented by airlines and methods for removing ice and preventing ice build up have improved. United States Federal Aviation Administration (FAA) regulations, as well as those of international regulatory authorities, clearly prohibit the takeoff of an aircraft when frost, ice, or snow is adhering to the aircraft's wings or other critical surfaces. Additionally, dispatch or takeoff of an aircraft is prohibited by the FAA when environmental conditions indicate a reasonable expectation that frost, ice, or snow may adhere to aircraft surfaces, unless there is in place an approved ground deicing and anti-icing program. An aircraft with frost, ice, and/or snow on its wings cannot operate aerodynamically and may be at risk for problems caused by increased drag and stall speed and uneven lift.

Ground crews and/or contractors are usually charged with carrying out the procedures required to remove frost, ice, and snow from aircraft surfaces and the procedures required to prevent the build up of these frozen contaminants on aircraft surfaces. Deicing and anti-icing procedures typically involve the application of liquids formulated to melt frozen water and to prevent it from re-forming on aircraft surfaces. In some situations, these fluids are heated to improve melting. The fluids used to deice runways are different from those used on aircraft surfaces, and the two types of fluids may not be compatible. Runway deicing fluids, moreover, both alone and in combination with aircraft surface deicing fluids, can damage aircraft surfaces on wings and tails as well as wheel brakes, electrical system connectors, and hydraulic system components. It is generally recommended that deicing fluids not be sprayed directly onto aircraft engines, wheels, brake assemblies, landing gear structures, and other sensitive aircraft structures. Whether deicing fluids are sprayed intentionally or unintentionally on or into aircraft engines and engine components, the potential for damage can be significant.

The deicing of runways may effectively melt ice or snow. The melted ice and snow form slush, however, which can build up on aircraft wheels and landing gear, including landing gear doors, bays, and switches, and other aircraft structures on the runway side of an aircraft. To help mitigate this, it is recommended that slush, frost, ice, and snow be removed from areas where an aircraft's nose and main landing gear tires will be positioned when the aircraft is parked at a gate or parking location. It is also recommended that these contaminants be removed from the aircraft's wheels, landing gear, and other structures prior to takeoff. The Association of European Airlines (AEA) states that the application of deicing fluid should not be directed into engine inlets or directly onto engine probes or sensors. Moreover, all reasonable precautions should be taken to minimize deicing fluid entry into engines, the auxiliary power unit, and other cavities in the vicinity of engines. The use of deicing fluids in landing gear and wheel bay areas should also be kept to a minimum, if used at all. The use of means other than fluid, such as mechanical removal, air blast, heat, and hot air are recommended by the AEA to remove accumulations of blown snow. Deposits of snow or slush that have accumulated can be removed with hot air or hot deicing fluids. The aforementioned procedures may effectively remove frozen water deposits, such as slush and the like, from wheels, landing gear, and wheel bays prior to departure from a gate or a deicing station. Since the use of anti-icing agents on these structures is generally prohibited, there is no guarantee that additional deposits will not be accumulated during taxi on a treated wet or slushy runway prior to takeoff.

When there is ice, slush, snow, or standing water on runways or taxiways, various structures on an aircraft taxiing in these conditions are likely to pick up frozen contaminants and may even be damaged. Taxiing in these conditions with the flaps extended, for example, subjects flaps and flap devices to frozen contamination that could prevent their movement. It is generally recommended that aircraft taxi at reduced speeds when ice, slush, snow, and standing water are present and limit thrust to the minimum required. Aircraft pilots are advised to avoid using reverse thrust on runways, taxiways, and ramps that are snow or slush-covered unless absolutely necessary. When reverse thrust is used, slush, water, and runway deicers can become airborne and adhere to aircraft wing surfaces.

Snow, slush, partially melted ice, water, and deicers can also present problems when aircraft are taxiing from a gate to a deicing location prior to takeoff, even when aircraft engines are operating at the minimum thrust needed to move the aircraft on the ground. Ice, snow, water mixed with deicing chemicals used to deice the ground surfaces, and whatever else happens to be on the ground can be sprayed into the air by operation of the aircraft engines and will stick to aircraft surfaces or find their way into openings in the aircraft surface. If the deicing chemicals, in particular, get into the engines, not only will engine operating efficiency be affected, but the engines could be damaged.

Airports that regularly conduct deicing operations usually have deicing stations, and departing aircraft will taxi to a deicing station to be sprayed with deicing fluid prior to takeoff. When an aircraft arrives at the deicing station, the engines must be shut down and stop rotating before the deicing operation can be carried out. This prevents deicing fluid sprayed on the aircraft wings and other surfaces from being ingested into the engine, but extends the time period between an aircraft's departure from a gate and takeoff.

Once an aircraft has been sprayed with deicing fluids at a deicing station, it must still travel on a runway that is likely to be, at a minimum, wet, and may even be snow or slush-covered before actually taking off. When the aircraft's engines are running during taxi under these conditions, and there is a line of aircraft waiting for takeoff after having been deiced, ice, snow, slush, deicing fluid, and other materials from the runway can be sprayed up onto other aircraft. This results in coating surfaces of other aircraft with these materials and, ultimately, reducing the efficiency of the deicing process.

The movement of an aircraft on the ground during taxi with motors designed to move the aircraft's wheels with minimal or no assistance from the aircraft's main engines has been proposed. In U.S. Pat. Nos. 7,445,178 to McCoskey et al and 7,226,018 to Sullivan, for example, systems able to move aircraft on the ground during taxi using wheel motors are described. U.S. Pat. Nos. 7,975,960 and 8,220,740 to Cox et al, owned in common with the present application, describe a nose wheel control apparatus capable of driving a taxiing aircraft independently on the ground. None of these patents or publications, however, describes using the wheel motors or systems disclosed therein in adverse cold weather environmental conditions or that these devices have any function to prevent some of the situations described above to enhance the efficiency of airport deicing operations when snow, ice, slush, or other frozen contaminants are present on taxiway and runway surfaces.

A need exists for a method for increasing the efficiency of airport deicing operations that avoids the need for repeated deicing of aircraft surfaces contaminated with runway slush and other liquid or frozen contaminants deposited by engine operation of adjacent aircraft during taxi.

### SUMMARY OF THE INVENTION

It is a primary object of the present invention, therefore, to provide a method for increasing the efficiency of airport deicing operations that overcomes the deficiencies of the prior art and prevents the need for repeated deicing of aircraft surfaces that results from the deposit of frozen contaminants produced by engine operation in adjacent aircraft during taxi.

It is another object of the present invention to provide a method for increasing the efficiency of airport deicing operations that reduces the time required to deice an aircraft and maintain the aircraft in a deiced condition for takeoff.

It is an additional object of the present invention to provide a method for substantially eliminating the damage to aircraft caused by taxiway and runway slush, snow, ice, and deicing chemicals sprayed onto aircraft surfaces by operation of an aircraft's engines during taxi prior to takeoff.

It is a further object of the present invention to provide a method for increasing the efficiency of airport deicing operations that moves aircraft through a deicing station or process in an optimum minimum amount of time to effectively deice the aircraft and to ensure that the aircraft remains deiced.

In accordance with the aforesaid objects, a method for improving the efficiency of airport deicing operations is provided. The present method equips the aircraft using an airport with onboard non-engine drive means powered to drive one or more landing gear wheels to move the aircraft on the ground autonomously during taxi without reliance on the aircraft's engines. The more aircraft at an airport that are equipped with onboard non-engine drive means capable of moving the aircraft during taxi between departure from a gate or other departure location, a deicing station or location, and a runway takeoff location, the less time aircraft engines must be used during taxi. Decreasing the operation of aircraft engines during taxi reduces the amount of runway contaminants moved by aircraft engines from the runway onto aircraft surfaces, both prior to deicing and after deicing. Repeated deicing operations on a single aircraft can be substantially eliminated.

Other objects and advantages will be apparent from the following description, drawings, and claims.

### BRIEF DESCRIPTION OF THE DRAWING

FIG. 1 illustrates a top view of aircraft, each of which is equipped with onboard non-engine drive means powered to drive one or more landing gear wheels to move the aircraft on the ground autonomously during taxi without reliance on the aircraft's engines on a runway after being deiced, waiting for takeoff.

### DESCRIPTION OF THE INVENTION

The importance of removing ice and other frozen contaminants from aircraft surfaces and structures and preventing the build up of frozen contaminants cannot be overstated. Procedures currently in use prior to takeoff are generally effective in deicing exposed aircraft surfaces and applying anti-icing agents to those surfaces to prevent ice build up during flight. When taxiways and runways are wet or covered with frozen or partially frozen contaminants, such as frost, ice, snow, or slush, aircraft wheels directly contact these frozen contaminants, and landing gear components and other structures of a taxiing aircraft may be sprayed with melting snow or slush during taxi. If the sprayed liquid or slush contains deicing chemicals and reaches the engines, damage to the engine structures is likely.

The surfaces of aircraft in the vicinity of a taxiing aircraft can also be sprayed with these contaminants. If the spraying of frozen contaminants occurs after an aircraft has been deiced, the likelihood of these partially frozen and frozen contaminants remaining in place is high. When outside air temperatures are below freezing, which is likely to be encountered when an aircraft travels at high altitudes, water and partially frozen contaminants on wheels and surrounding structures can re-freeze when the aircraft is in flight. Even a relatively small amount of ice formed by residual frozen fluids can have adverse effects on an aircraft. Icing on aircraft wings can add weight to the aircraft and change the aerodynamic shape of the wing, both of which adversely affect lift. Icing around the flaps can interfere with their operation. Additionally, moisture condensing on interior components of the wings can pose significant problems. Ice in the landing gear can interfere with extension of the landing gear when the aircraft is cleared for landing. The forces required to extend a landing gear covered with ice might be greater than the landing gear extension mechanism can handle, which could result in damage to these structures or, possibly, a landing gear that will not extend at all and an aircraft that is unable to land. Additionally, if a significant amount of ice accumulates inside the landing gear bay doors, these doors could be prevented from opening.

In addition to the challenges posed by ice, snow, slush, and frozen contaminants to the effective functioning of individual aircraft, airport operation can also be adversely affected their presence. Safety regulations require the removal of frozen contaminants from aircraft surfaces by deicing operations prior to takeoff. Anti-icing agents may also be applied to aircraft surfaces after they are deiced. As discussed above, when aircraft have been deiced and anti-icing agents applied to ready an aircraft for takeoff, these procedures can be negated when an aircraft's surfaces are sprayed with frozen or partially frozen runway materials by the operating engines of an adjacent aircraft. The sprayed aircraft could require additional applications of deicing and anti-icing chemicals. Not only does this take time, but the use of greater quantities of chemicals presents its own problems. Any time the takeoff of an aircraft is delayed, the efficiency of airport operations is reduced at both the aircraft's departure airport and the aircraft's destination airport. The method of the present invention substantially reduces the likelihood of this happening from delays caused by repeated deicing of aircraft resulting from engine operation during taxi.

To employ the method of the present invention, an aircraft must be equipped with onboard non-engine drive means positioned to drive one or more of the aircraft's landing gear wheels during ground travel without reliance on the aircraft's main engines. A powered self-propelled nose or main landing gear wheel is uniquely positioned to maneuver an aircraft in a variety of circumstances on the ground. The non-engine drive means for the powered drive wheel optimally exerts sufficient power to move the aircraft at runway speeds, even in adverse runway conditions, and its small size enables a non-engine drive means to fit within a drive wheel, in the landing gear space, or in another convenient location. An aircraft with a powered self-propelled nose landing gear wheel or main landing gear wheel may have one or more non-engine drive means mounted in driving relationship with one or more of the aircraft landing gear wheels to move the wheels at a desired speed and torque.

Non-engine drive means useful for this purpose may be selected from those known in the art. One preferred drive means is a high phase order electric motor of the kind described in, for example, U.S. Pat. Nos. 6,657,334; 6,838,791; 7,116,019; and 7,469,858, all of which are owned in common with the present invention. A geared motor, such as that shown and described in U.S. Pat. No. 7,469,858, is designed to produce the torque required to move a commercial sized aircraft at an optimum speed for ground movement. The disclosures of the aforementioned patents are incorporated herein by reference. Any form of electric, pneumatic, or hydraulic drive means capable of driving an aircraft on the ground, including but not limited to electric induction motors, permanent magnet brushless DC motors, switched reluctance motors, hydraulic pump/motor assemblies, and pneumatic motors may also be used to power aircraft drive wheels in accordance with the present invention. Other motor designs capable of high torque operation across a preferred speed range that can be integrated into an aircraft drive wheel to function as described herein may also be suitable for use in the aircraft ground movement system of the present invention. A preferred source of power for electric non-engine drive means is the aircraft auxiliary power unit (APU), although other sources of power may also be used and are contemplated to be within the scope of the present invention.

An aircraft equipped with a non-engine drive means described above is designed to be controllable by a pilot in the aircraft cockpit or remotely from another location to drive the aircraft independently on the ground during taxi without reliance on the aircraft's main engines. When the aircraft is cleared for departure, the non-engine drive means is activated to move the aircraft on the ground in reverse during pushback and then in a forward direction to taxi to a runway for takeoff. As the aircraft is propelled or moved on the ground by the drive means, some ice, snow, or slush from untreated runway surfaces and water and deicing chemicals from treated runway surfaces may be deposited on the landing gear, wheels, and associated structures close to the runway. Because the aircraft's engines are not operating, these contaminants are highly unlikely to be sprayed onto aircraft wings or other surfaces on the taxiing aircraft or adjacent aircraft.

When the aircraft is moved by the onboard non-engine drive means to a deicing station or an area where deicing procedures are conducted, the deicing procedure can begin immediately since the aircraft engines do not have to be turned off, and there is no wait for the engines to stop rotating. After the deicing procedure has been completed, the aircraft can taxi immediately to a takeoff runway without spraying the surfaces of nearby aircraft with runway contaminants. The number of aircraft that can be deiced in a selected time interval can be significantly increased over the number that may be accommodated when aircraft use their engines for taxi and ground movement.

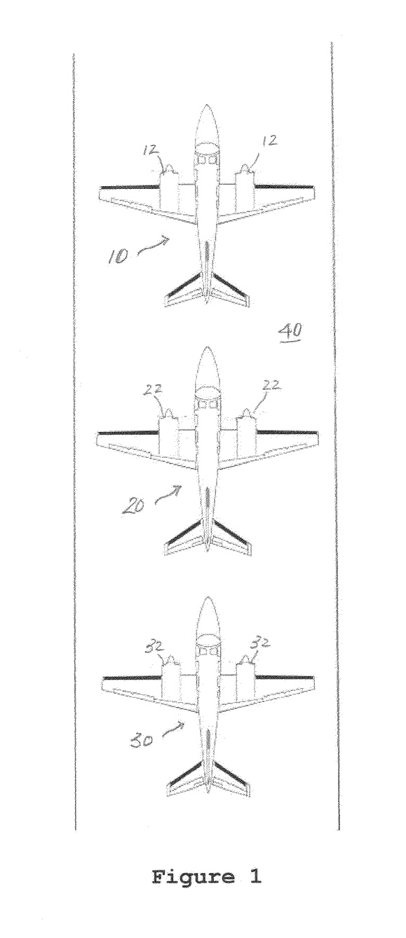

If aircraft are required to wait in line for takeoff, as shown in FIG. 1, the engines do not have to be turned on until the appropriate interval before actual takeoff, which further substantially eliminates deposits of runway contaminants caused by engine operation. Costly and time-consuming repeated deicing procedures are avoided, and aircraft may be moved efficiently from a gate to takeoff in adverse runway and weather conditions.

FIG. 1 shows three aircraft 10, 20, and 30 lined up on a runway 40 after deicing, waiting for takeoff. When the engines 12, 22, and 32 are operating as aircraft 10, 20, and 30 await takeoff, jet blast, also known as jet efflux, from these engines may generate significant forces that can move snow, slush, and other runway materials a substantial distance behind the aircraft. Jet blast data, measured from an aircraft's tail with the engines at low RPM settings, indicates that the jet blast profile can extend from the outboard wing-mounted engines to more than 200 feet beyond some larger aircraft. Within this area, jet engines can generate hurricane-level exhaust forces of almost 100 knots. If the engines 12 on aircraft 10 are operating, even at idle, aircraft 20 will be sprayed with whatever is caught up in the jet blast stream from engines 12 if aircraft 20 is within the jet blast hazard area. When aircraft are moving on taxi runways with operating engines and weather conditions reduce visibility, or when ground or air traffic control do not direct an aircraft pilot to maintain a safe prescribed distance behind an aircraft in front of it, jet blast from the aircraft ahead will spray frozen and partially frozen runway contaminants on the aircraft behind. An aircraft that has been sprayed with frozen and partially frozen runway contaminants by the aircraft in front of it takes off with these contaminants if the sprayed aircraft cannot be deiced again. With the method of the present invention, aircraft engines are not operating, and jet blast is not an issue. Whether an aircraft is within the jet blast hazard zone of the aircraft in front of it in line is not is not a consideration when the aircraft's engines are not needed to move the aircraft.

While the present invention has been described with respect to preferred embodiments, this is not intended to be limiting, and other arrangements and structures that perform the required functions are contemplated to be within the scope of the present invention.

### INDUSTRIAL APPLICABILITY

The present invention will find its primary applicability in providing a method for improving the efficiency of airport deicing operations when it is desired to avoid repeat deicing of aircraft during adverse weather conditions and to avoid the spraying of ice, snow, slush, and frozen contaminants present on airport runway surfaces are likely onto surfaces of adjacent aircraft when aircraft engines are operating. Equipping aircraft with onboard non-engine drive means for autonomous taxi avoids these situations and enhances efficiency of airport deicing operations.

1. A method comprising increasing the efficiency of airport deicing operations by substantially reducing time required for deicing operations and substantially avoiding a need to conduct repeat deicing procedures on aircraft required by the presence of wet or frozen runway contaminants sprayed by operating engines of adjacent aircraft, wherein each of a plurality of aircraft using airport facilities is equipped with onboard non-engine drive means powered to drive one or more landing gear wheels to move each aircraft autonomously on the ground during taxi without operating aircraft engines; and
wherein the presence of airborne wet or frozen runway contaminants within a jet blast danger zone area of each of said plurality of aircraft driven autonomously on the ground by non-engine drive means is eliminated.

2. The method described in claim 1, wherein said onboard non-engine drive means is selected from the list comprising electric induction motors, permanent magnet brushless DC motors, switched reluctance motors, hydraulic pump/motor assemblies, and pneumatic motors.

3. The method described in claim 1, wherein said one or more landing gear wheels comprises one or more nose landing gear wheels or one or more main landing gear wheels.

4. The method described in claim 1, wherein each of said plurality of aircraft is driven autonomously on a ground surface covered with ice, snow, slush, and frozen contaminants in the vicinity of other aircraft while substantially eliminating the spraying and deposit of ice, snow, slush, and frozen contaminants on surfaces of said aircraft and on surfaces of said other aircraft.

5. The method described in claim 1, further comprising increasing the number of said plurality of aircraft and other aircraft at an airport that can be deiced in a selected time interval is increased.

6. The method described in claim 1, further comprising reducing aircraft takeoff delays caused by delays in deicing procedures.

7. The method described in claim 1, further comprising improving airport operating efficiency by reducing aircraft takeoff delays in adverse winter weather and under adverse runway conditions.

8. The method described in claim 1, further comprising substantially eliminating damage to aircraft surfaces caused by runway deicing chemicals sprayed by operation of aircraft engines during taxi.

9. A method for improving efficiency of airport deicing operations, comprising:
a. equipping aircraft landing and taking off at an airport with one or more non-engine drive means mounted to drive the aircraft autonomously without operation of aircraft engines;
b. using the non-engine drive means to drive said aircraft on runway surfaces covered with wet or frozen contaminants comprising at least snow, ice, and slush;
c. using said non-engine drive means to drive said aircraft to a de-icing station and substantially immediately using a de-icing process on said aircraft to remove frozen contaminants present on said aircraft;
d. substantially immediately after completion of de-icing, using said non-engine drive means to drive said aircraft to a runway for takeoff; and
e. operating the aircraft's engines to cause the aircraft to take off without repeating a de-icing process to remove frozen contaminants sprayed on said aircraft by operation of engines of adjacent aircraft.

10. The method of claim 9, further comprising equipping all or a plurality of aircraft at said airport with non-engine drive means.

11. The method of claim 10, further comprising enabling aircraft driven to a runway for taxi to wait in a line for takeoff without a front aircraft spraying frozen contaminants on an aircraft behind said front aircraft, thereby eliminating a need to repeat said de-icing process and preventing aircraft with frozen contaminants from taking off.

12. The method of claim 11, wherein a pilot of an aircraft waiting in line behind a front aircraft maintains visibility of said front aircraft and a safe prescribed distance from said front aircraft.
